(19) United States
(12) Patent Application Publication
(10) Pub. No.: US 2010/0321875 A1
(43) Pub. Date: Dec. 23, 2010

(54) ELECTRONIC DEVICE

(75) Inventor: Yi-Hung Hsieh, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/775,488

(22) Filed: May 7, 2010

(30) Foreign Application Priority Data
Jun. 19, 2009 (TW) 98120730

(51) Int. Cl. G06F 1/16

(52) U.S. Cl. 361/679.06

(57) ABSTRACT

An electronic device includes a main body, an input unit, a screen, and a connecting mechanism. The main body has a first side and a second side next to the first side. The input unit is disposed on the main body. The connecting mechanism is connected with the main body and the screen. The screen is adjacent to the first side or the second side of the main body via the connecting mechanism. When the screen is at the first side of the main body, a display direction of the screen and a display direction of symbols of the input unit are parallel to an extending direction of the first side. When the screen is at the second side of the main body, the display direction of the screen and the display direction of the symbols of the input unit are vertical to an extending direction of the second side.

### CROSS-REFERENCE TO RELATED APPLICATION

This application claims the priority benefit of Taiwan application serial no. 98120730, filed on Jun. 19, 2009. The entirety of the above-mentioned patent application is hereby incorporated by reference herein and made a part of this specification.

### BACKGROUND OF THE INVENTION

1. Field of the Invention

The invention relates to an electronic device and, more particularly, to an electronic device whose screen may be moved relative to a main body.

2. Description of the Related Art

Presently, a notebook in the market is usually designed to be light and thin for a user to carry and use readily. However, the structure of the notebook still has some deficiencies. For example, a conventional notebook is usually put on a platform, and the user needs to adjust his or her positions to fit the height of the platform to use the notebook. As a result, the user feels tired in a short time in the inconvenient usage condition.

On the other hand, when the user holds the notebook by hands, an opening angle between a screen and an input unit of an unfolded notebook affects a position of the gravity centre of the notebook. As a result, it is hard for the user to stably hold the notebook in hands, and the notebook even may be fallen off from the hands of the user.

### BRIEF SUMMARY OF THE INVENTION

The invention discloses an electronic device which a user may easily operate.

An electronic device according to the invention includes a main body, an input unit, a screen, and a connecting mechanism. The main body has a first side and a second side next to the first side. The input unit is disposed on the main body. The connecting mechanism is connected with the main body and the screen. The screen is adjacent to the first side or the second side of the main body via the connecting mechanism. When the screen is at the first side of the main body, a display direction of the screen and a display direction of symbols of the input unit are both parallel to an extending direction of the first side. When the screen is at the second side of the main body, a display direction of the screen and the display direction of the symbols of the input unit are both vertical to an extending direction of the second side.

In an embodiment of the invention, the connecting mechanism includes a rotating arm and a rotating shaft. A first end of the rotating arm is pivotally connected with the second side of the main body. The rotating shaft is pivotally connected with a second end of the rotating arm and the screen.

In an embodiment of the invention, the rotating arm rotates relative to the main body around a first axis, the rotating shaft rotates relative to the rotating arm around a second axis, and the first axis is parallel to the second axis.

In an embodiment of the invention, the screen rotates relative to the rotating shaft around a third axis, and the second axis is vertical to the third axis.

In an embodiment of the invention, the second side of the main body has a recess for containing the rotating arm.

As stated above, the screen of the electronic device according to the invention may move between the first side and the second side of the main body via the connecting mechanism. When the screen is at the first side of the main body, a display direction of the screen and a display direction of the symbols of the input unit are both parallel to an extending direction of the first side. Similarly, when the screen is at the second side of the main body, a display direction of the screen and the display direction of the symbols of the input unit are both vertical to an extending direction of the second side. In other words, the direction in which the user sees the screen is the same as the direction in which the user operates the input unit regardless the screen at the first side or the second side of the main body. Consequently, the disposition directions of the input unit and the screen of the electronic device can meet the demands of the user, and the user may hold and operate the electronic device with a more labor-saving gesture.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an electronic device according to an embodiment of the invention.

FIG. 2 is a schematic diagram showing the electronic device in FIG. 1 in another state according to an embodiment of the invention.

FIG. 3 and FIG. 4 are schematic diagrams showing that the state of the electronic device is converted from the state in FIG. 1 to the state in FIG. 2 according to an embodiment of the invention.

### DETAILED DESCRIPTION OF THE EMBODIMENTS

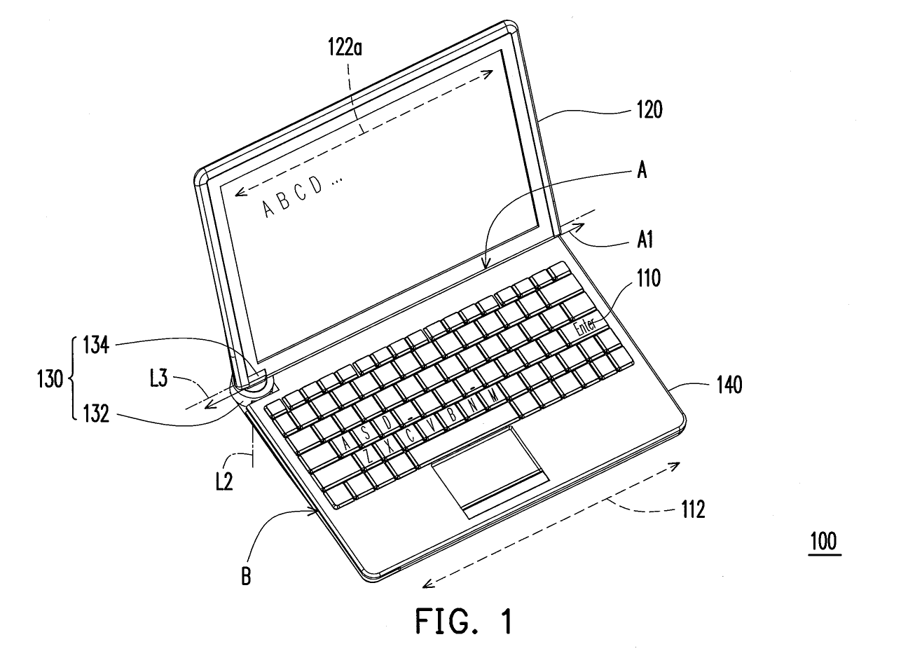

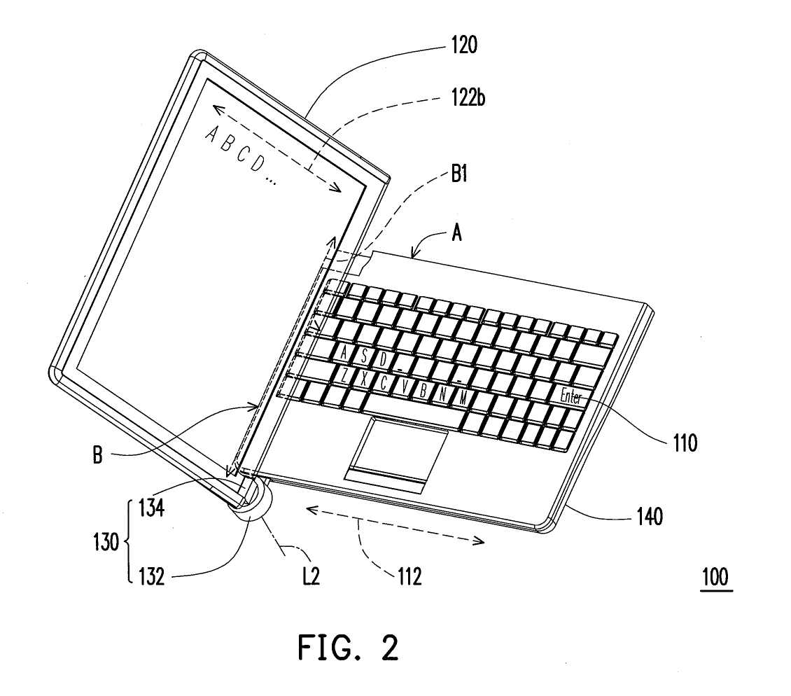

FIG. 1 is a schematic diagram showing an electronic device according to an embodiment of the invention. FIG. 2 is a schematic diagram showing the electronic device in FIG. 1 in another state according to an embodiment of the invention. In FIG. 1 and FIG. 2, an electronic device 100 is a notebook, and it also may be a mobile phone, a personal digital assistant (PDA) or one of other electronic devices. The electronic device 100 includes a main body 140, an input unit 110, a screen 120, and a connecting mechanism 130. The main body 140 has a first side A and a second side B next to the first side A. The input unit 110 is disposed on the main body 140. The connecting mechanism 130 is connected with the main body 140 and the screen 120. The screen 120 is adjacent to the first side A or the second side B of the main body 140 via the connecting mechanism 130. That is, the connecting mechanism 130 allows the screen 120 to move and rotate relative to the main body 140 and allows the screen 120 to be adjacent to the first side A or the second side B of the main body 140. When the screen 120 is at the first side A of the main body 140, a display direction 122a of the screen 120 and a display direction 112 of symbols of the input unit 110 are both parallel to an extending direction A1 of the first side A. When the screen 120 is at the second side B of the main body 140, a display direction 122b of the screen 120 and the display direction 112 of the symbols of the input unit 110 are both vertical to an extending direction B1 of the second side B. In other words, in each state of the two states as stated above, the direction in which the user sees the screen 120 is the same as the direction in which the user watches the input unit 110.

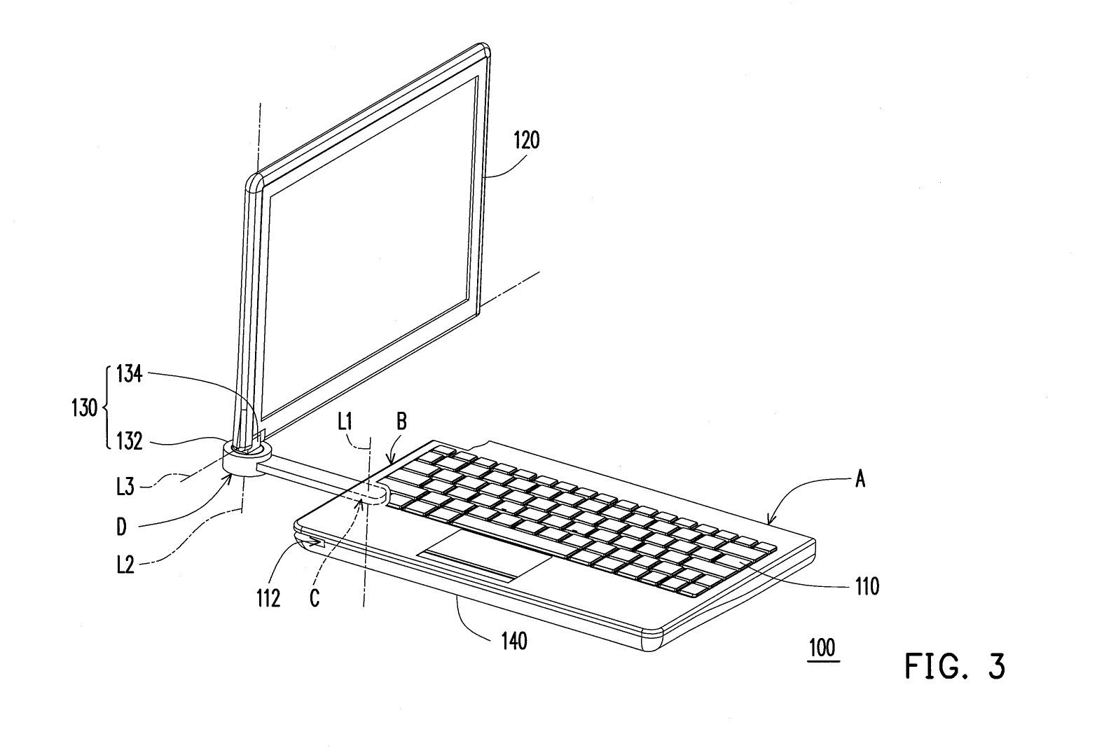

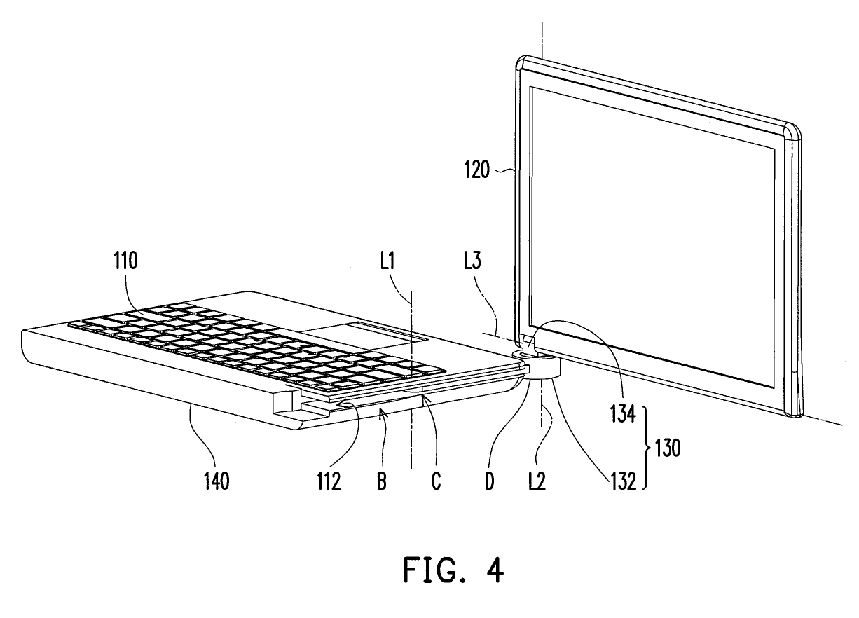

As stated above, the screen 120 of the electronic device 100 may move from the first side A of the main body 140 to the second side B of the main body 140. In contrast with the conventional notebook whose screen and main body only can be opened and closed, the electronic device 100 in this embodiment provides the user a new operation mode. In this mode, regardless of the value of an included angle between the screen 120 and the main body 140, the position of the gravity centre of the entire electronic device 100 is almost kept at an adjacent part between the screen 120 and the main body 140. The user only needs to hold the screen 120 and the second side B of the main body 140, he or she can stably hold the electronic device 100 at any time. Furthermore, regardless of the screen 120 at the first side A or the second side B of the main body 140, the direction in which the user sees the screen 120 is the same as the direction in which the user watches the input unit 110. As a result, the user may hold the electronic device 100 with one hand and operate the electronic device 100 with the other hand via the input unit 110, and he also may smoothly see the screen 120 at the same time. FIG. 3 and FIG. 4 are schematic diagrams showing that the state of the electronic device is converted from the state in FIG. 1 to the state in FIG. 2 according to an embodiment of the invention. In the embodiment, the connecting mechanism 130 includes a rotating arm 132 and a rotating shaft 134. A first end C of the rotating arm 132 is pivotally connected with the second side B of the main body 140, and the rotating arm 132 rotates relative to the main body 140 around the first axis L1. Additionally, the rotating shaft 134 is pivotally connected with a second end D of the rotating arm 132 and the screen 120. The rotating shaft 134 rotates relative to the rotating arm 132 around the second axis L2, and the screen 120 rotates relative to the rotating shaft 134 around a third axis L3. The second axis L2 is parallel to the first axis L1, and the second axis L2 is vertical to the third axis L3. Moreover, the second side B of the main body 140 has a recess 112. When the screen 120 is at the first side A or the second side B of the main body 140, the rotating arm 132 may be contained in the recess 112, and thus the space for containing the connecting mechanism 130 in the electronic device 100 is efficiently reduced.

In this embodiment, as shown FIG. 1, a left side of the main body 140 is the second side B adjacent to the screen 120. However, a right side of the main body 140, which is the side opposite to the second side B of the main body 140, may be defined as the side adjacent to the screen 120 to make the extended electronic device 100 adapted for a left-hander.

As stated above, to make the screen 120 move from the first side A of the main body 140 to the second side B of the main body 140, as shown in FIG. 1, the user may rotate the screen 120 around the third axis L3 to make the screen 120 opened from the main body 140. Afterward, as shown in FIG. 3 and FIG. 4, the rotating arm 132 and the screen 120 rotates around the first axis L1 to make the screen 120 rotate relative to the main body 140 from the position as shown in FIG. 1 to the position as shown in FIG. 4 via the position as shown in FIG. 3. Finally, as shown in FIG. 2 and FIG. 4, the user rotates the screen 120 around the second axis L2 via the rotating shaft 134 to make the screen 120 and the main body 140 be in the state as shown in FIG. 2.

The mode of rotating the connecting mechanism 130 is not limited herein in this invention. In other embodiments, the rotating shaft 134 in the above embodiment also may be replaced by a universal joint. On the other hand, the order of moving and rotating the screen 120 relative to the main body 140 is also not limited.

In FIG. 1 and FIG. 2, to still allow the user to operate the input unit 110 and see the screen 120 at the same time after the screen 120 moves from the first side A of the main body 140 to the second side B of the main body 140, the display directions 122a and 122b of the screen 120 when the screen 120 is at the first side A and the second side B of the main body 140 are different (The conversion between the display directions 122a and 122b of the screen may be realized via software control). The conversion between the display directions 122a and 122b of the screen 120 may be switched by the user himself or herself, and it also may be automatically switched by utilizing a sensor (not shown) to sense the change of the position of the screen 120 relative to the main body 140.

To sum up, since the screen of the electronic device according to the invention can move relative to the main body from the first side to the second side, the user may easily and stably hold the electronic device in an ergonomic way. Furthermore, the direction in which the user sees the screen is the same as the direction in which the user watches the input unit regardless of the screen at the first side or the second side of the main body, and thus the user may operate the input unit of the electronic device and sees the screen of the electronic device at the same time when he or she holds the electronic device. As a result, the electronic device according to the invention has a plurality of operating modes and preferred operating convenience.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device, comprising:
a main body having a first side and a second side next to the first side;
an input unit having a plurality of symbols and disposed on the main body;
a screen; and
a connecting mechanism connected with the main body and the screen, when the screen is at the first side of the main body, a display direction of the screen and a display direction of the symbols of the input unit are both parallel to an extending direction of the first side, and when the screen is at the second side of the main body, the display direction of the screen and the display direction of the symbols of the input unit are both vertical to an extending direction of the second side.

2. The electronic device according to claim 1, wherein the connecting mechanism comprises:
a rotating arm, wherein a first end of the rotating arm is pivotally connected with the second side of the main body; and
a rotating shaft pivotally connected with a second end of the rotating arm and the screen.

3. The electronic device according to claim 2, wherein the rotating arm rotates relative to the main body around a first axis, the rotating shaft rotates relative to the rotating arm around a second axis, and the first axis is parallel to the second axis.

4. The electronic device according to claim 3, wherein the screen rotates relative to the rotating shaft around a third axis, and the second axis is vertical to the third axis.

5. The electronic device according to claim 2, wherein the second side of the main body has a recess for containing the rotating arm.
